(19) United States
(12) Patent Application Publication
(10) Pub. No.: US 2005/0115084 A1
(43) Pub. Date: Jun. 2, 2005

(54) Cutter

(75) Inventor: Katsumi Hasegawa, Seki-shi (JP)

Correspondence Address: POSZ LAW GROUP, PLC, 12040 SOUTH LAKES DRIVE, SUITE 101, RESTON, VA, 20191, US

(73) Assignee: KAI R&D CENTER CO., LTD, Seki-shi (JP)

(21) Appl. No.: 10/502,645

(22) PCT Filed: Jan. 23, 2003
(86) PCT No.: PCT/JP03/00582

(30) Foreign Application Priority Data
Feb. 15, 2002 (JP) 2002-038439

(51) Int. Cl. B26B 9/02; B26B 3/00

(52) U.S. Cl. 30/355

(57) ABSTRACT

An edge 3 extending from a body 2 includes a plurality of recesses 4 and a plurality of projections 5, which are alternately formed in a continuous manner. The edge 3 also includes a plurality of projecting edge sections 6, each of which extends at distal and basal sides with respect to the tip of a corresponding one of the projections 5. Each projecting edge section 6 includes a distal slanted edge section 7 and a basal slanted edge section 8, which are connected to each other at the tip of the corresponding projection 5. The shape of each distal slanted edge section 7 is different from the shape of each basal slanted edge section 8.

### FIELD OF THE INVENTION

The present invention relates to an improved shape for the edge of a cutter including a plurality of recesses and a plurality of projections, which are alternately arranged along the edge extending from a cutter body.

### BACKGROND OF THE INVENTION

Conventionally, a plurality of recesses and a plurality of projections are formed alternately along the edge of a cutter, as described in, for example, Japanese Patent Publication No. 2949645. Each of the recesses includes an edge section that is a mirror image in shape with respect to a line that extends perpendicular to a line connecting the tips of the projections and passes the bottoms of the recesses. Each of the projections includes an edge section that is a mirror image in shape with respect to a line that extends perpendicular to the line connecting the tips of the projections and passes the tips of the projections.

In the aforementioned conventional art, the edge sections, each of which is a mirror image in shape in the corresponding recess or projection, are formed continuously in a wave-like shape. Therefore, when the cutter is moved in a reciprocating manner for cutting an object, the cutting characteristics of the cutter cannot be changed with respect to the object. That is, the cutting characteristics of the cutter are limited. However, for example, the optimal shape of the edge for cutting an object with a smooth surface layer is different from that for an object with an unsmooth surface layer. Therefore, if the edge is shaped uniformly, the edge may slip on the smooth surface layer or be caught by the unsmooth surface layer. The cutting performance of the cutter is thus hampered.

Accordingly, it is an objective of the present invention to improve the cutting performance of a cutter by changing the cutting characteristics of the cutter with respect to an object to be cut.

### DISCLOSURE OF THE INVENTION

A cutter according to the present invention, which is a cooking tool such as a bread cutter, is configured as follows.

One aspect of the present invention is a cutter including an edge extending from a body. The edge includes a plurality of recesses and a plurality of projections, which are alternately formed in a continuous manner. The edge also includes a plurality of projecting edge sections. Each of the projecting edge sections extends at distal and basal sides with respect to a tip of a corresponding one of the projections. Each projecting edge section has a distal slanted edge section and a basal slanted edge section, which are connected to each other at the tip of the corresponding projection. The shape of each distal slanted edge section is different from the shape of each basal slanted edge section.

If “the shape of each distal slanted edge section is different from the shape of each basal slanted edge section”, each of the distal and basal slanted edge sections does not form a mirror image, with respect to a predetermined line that extends perpendicular to a line connecting the tips of the projections and passes the tips, with reference to, for example, FIG. 2. Since each of the projecting edge sections has the differently shaped, distal and basal slanted edge sections, the cutting characteristics of the cutter can be changed with respect to an object to be cut, when the cutter is moved in a reciprocating manner. That is, the cutting characteristics of the cutter edge are not limited. By changing the cutting characteristics as needed, the cutting performance of the cutter is improved.

Another aspect of the present invention is a cutter including an edge extending from a body. The edge includes a plurality of recesses and a plurality of projections, which are alternately formed in a continuous manner. The edge also includes a plurality of projecting edge sections. Each of the projecting edge sections extends at distal and basal sides with respect to a tip of a corresponding one of the projections. Each projecting edge section has a distal slanted edge section and a basal slanted edge section, which are connected to each other at the tip of the corresponding projection. A plurality of zones having the projecting edge sections of different shapes are aligned along a line connecting the tips of the projections.

By providing the zones having the projecting edge sections of different shapes, the cutting characteristics of the cutter may be changed with respect to an object to be cut. That is, the cutting characteristics of the cutter edge are not limited. By changing the cutting characteristics as needed, the cutting performance of the cutter is improved.

Another aspect of the present invention is a cutter including an edge extending from a body. The edge includes a plurality of recesses and a plurality of projections, which are alternately formed in a continuous manner. The edge also includes a plurality of projecting edge sections. Each of the projecting edge sections extends at distal and basal sides with respect to a tip of a corresponding one of the projections. Each projecting edge section has a distal slanted edge section and a basal slanted edge section, which are connected to each other at the tip of the corresponding projection. The edge includes a first zone and a second zone, which are aligned along a line connecting the tips of the projections. In the first zone, the slanting angle of each basal slanted edge section with respect to the line is larger than the slanting angle of each distal slanted edge section with respect to the line. In the second zone, the slanting angle of each distal slanted edge section with respect to the line is larger than the slanting angle of each basal slanted edge section with respect to the line.

The cutter is used for pull cutting and push cutting, which may be performed independently in a repeated manner or in combination in a repeated alternating manner. Further, in each mode of cutting, the second zone (a push cut zone) and the first zone (a pull cut zone) of the edge may be used independently or in combination. For example, if the push cutting is performed on an object, a surface layer of the object may be cut with the distal slanted edge sections of the push cut zone, the slanting angles of which are relatively large, depending on certain conditions for cutting the object. If the pull cutting is performed on the object, the surface layer of the object may be cut with the basal slanted edge sections of the pull cut zone, the slanting angles of which are relatively large, depending on the conditions for cutting the object.

Further, even if the push cutting is performed on the object, the surface layer of the object may be cut with the distal slanted edge sections of the pull cut zone, the slanting angles of which are relatively small, depending on the conditions for cutting the object. In the same manner, even if the pull cutting is performed on the object, the surface layer of the object may be cut with the basal slanted edge sections of the push cut zone, the slanting angles of which are relatively small, depending on the conditions for cutting the object. In other words, the cutting modes and zones of the cutter are applied selectively depending on the conditions regarding the object to be cut. The cutting performance of the cutter is thus improved with respect to the object.

### BRIEF DISCRPTION OF THE DRAWINGS

FIG. 1(a) is a front view showing a bread cutter according to a first embodiment of the present invention;

FIG. 1(b) is a rear view showing the cutter;

FIG. 1(c) is a cross-sectional view showing a body of the cutter;

FIG. 2(a) is an enlarged front view showing a portion of an edge of the cutter illustrated in FIG. 1(a);

FIG. 2(b) is an enlarged front view showing a portion of an edge of a bread cutter of a modification of the first embodiment;

FIGS. 3(a) to 3(d) are views explaining the cutting operation of the bread cutter of the first embodiment;

FIG. 4(a) is a front view showing a bread cutter according to a second embodiment of the present invention; and

FIG. 4(b) is a front view showing a bread cutter according to a third embodiment of the present invention.

### BEST MODE FOR CARRYING OUT THE INVENTION

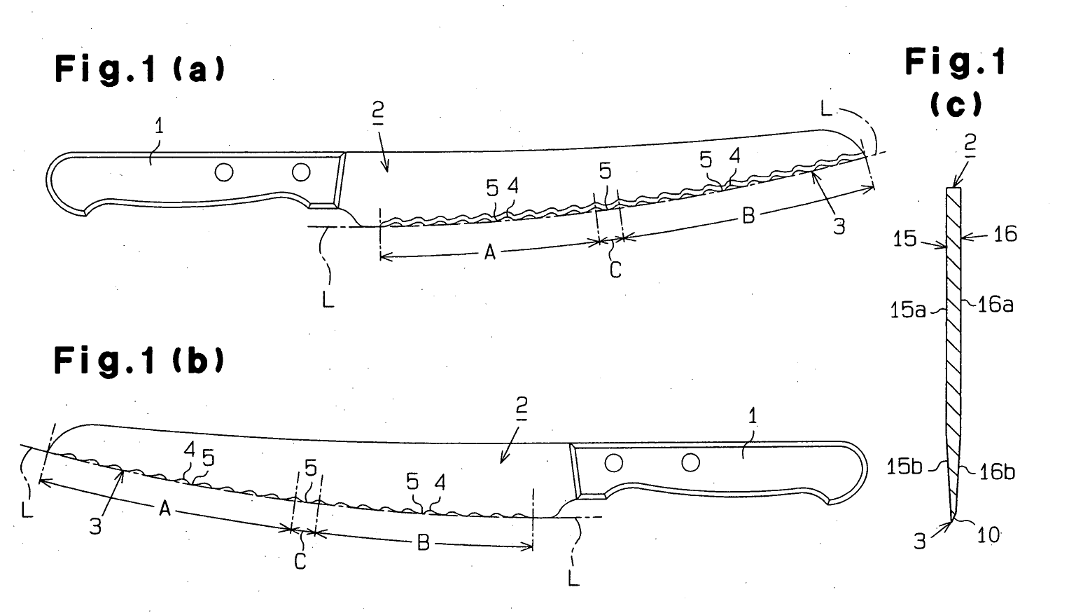

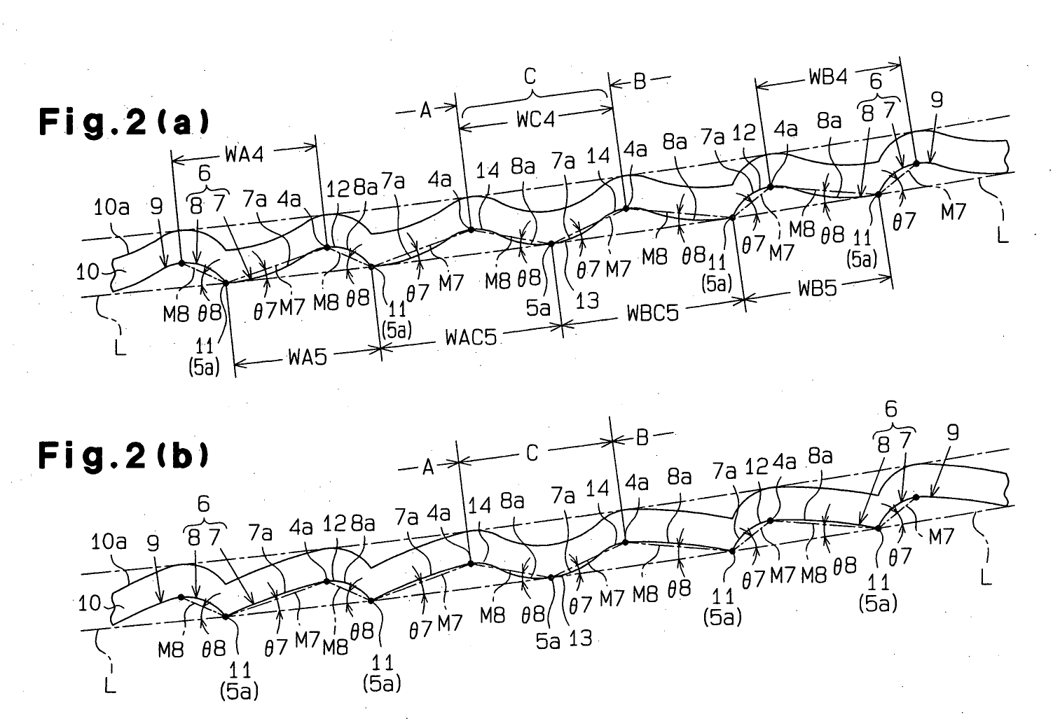

With reference to FIGS. 1(a) to 1(c), 2(a) and 3, a bread cutter as a cutter according to a first embodiment of the present invention will hereafter be described. As illustrated in FIGS. 1(a), 1(b), and 2(a), a body 2 is secured to a handle 1. A wave form edge 3 extends along a bottom side of the body 2. A plurality of recesses 4 and a plurality of projections 5 are arranged alternately and continuously along the edge 3. Each of the projections 5 has a projecting edge section 6. Each of the projecting edge sections 6 extends at distal and basal sides with respect to the tip 5a of a corresponding one of the projections 5. Each projecting edge section 6 has a distal slanted edge section 7 and a basal slanted edge section 8, which are connected to each other at the tip 5a of the corresponding projection 5. Each of the recesses 4 has a recessed edge section 9. Each of the recessed edge sections 9 extends at distal and basal sides with respect to the bottom 4a of a corresponding one of the recesses 4. Each recessed edge section 9 includes the distal slanted edge section 7 and the basal slanted edge section 8, which are connected to each other at the bottom 4a of the corresponding recess 4.

With reference to FIGS. 1(a), 1(b), and 2(a), the edge 3 includes a plurality of zones that have the projecting edge section 6 and the recessed edge section 9 of different shapes. The zones are arranged along an edge line L connecting the tips 5a of the projections 5. The zones include a pull cut zone A serving as a first zone, a push cut zone B serving as a second zone, and an intermediate zone C serving as a third zone, which is disposed between the zones A, B.

The pull cut zone A is arranged at a basal portion of the body 2. The push cut zone B is arranged at a distal portion of the body 2. The intermediate zone C is formed by the single projection 5 located between the pull cut zone A and the push cut zone B. In the pull cut zone A, the tips 5a of adjacent ones of the projections 5 are spaced from each other at an interval WAS defined along the edge line L. In the push cut zone B, the tips 5a of adjacent ones of the projections 5 are spaced from each other at an interval WB5 defined along the edge line L. The interval WAS is equal to the interval WB5. Likewise, in the pull cut zone A, the bottoms 4a of adjacent ones of the recesses 4 are spaced from each other at an interval WA4 defined along the edge line L. In the push cut zone B, the bottoms 4a of adjacent ones of the recesses 4 are spaced from each other at an interval WB4 defined along the edge line L. The interval WA4 is equal to the interval WB4. Further, the intervals WA4, WB4 are equal to the intervals WAS, WB5.

In the intermediate zone C, the bottoms 4a of the two corresponding recesses 4, which are located at opposing sides of the tip 5a of the single projection 5, are spaced from each other at an interval WC4 defined along the edge line L. The interval WC4 is substantially equal to the intervals WAS, WB5, WA4, and WB4. However, in the boundary portion between the intermediate zone C and the pull cut zone A, the tips 5a of the adjacent projections 5 are spaced from each other at an interval WAC5. Likewise, in the boundary portion between the intermediate zone C and the push cut zone B, the tips 5a of the adjacent projections 5 are spaced from each other at an interval WBC5. The intervals WAC5, WBC5 are larger than the intervals WAS, WB5, WA4, and WB4.

As illustrated in FIG. 1(c), the body 2 has opposing side surfaces 15, 16 respectively including side surface sections 15a, 16a. The side surface sections 15a, 16a extend substantially parallel with each other, from a top side of the body 2, which is opposed to the edge 3, toward the bottom side of the body 2. The side surfaces 15, 16 also include slanted surface sections 15b, 16b, respectively. The slanted surface sections 15b, 16b extend from the associated side surface sections 15a, 16a to the edge 3 in a slanted manner at a predetermined angle. At the edge 3, only the slanted surface section 16b includes a slanted edge forming surface 10 formed in a slanted manner at an angle of 30 to 40 degrees. The slanted surface section 16b includes a boundary line 10a shaped correspondingly to the shapes of the projecting edge sections 6 and the recessed edge sections 9. The boundary line 10a extends parallel with the outline of the projecting edge sections 6 and the recessed edge sections 9.

With reference to FIG. 2(a), the shape of each distal slanted edge section 7 and the shape of each basal slanted edge section 8 are different from each other, as will be described in the following.

In the pull cut zone A, the slanting angle θ8 of each basal slanted edge section 8 with respect to the edge line L is larger than the slanting angle θ7 of each distal slanted edge section 7 with respect to the edge line L (θ7<θ8). The slanting angle θ8 corresponds to the angle of a slanted line M8 (a line extending substantially along the basal slanted edge section 8), which connects the tip 5a of each projection 5 and the bottom 4a of the associated recess 4, with respect to the edge line L. The slanting angle θ7 corresponds to the angle of a slanted line M7 (a line extending substantially along the distal slanted edge section 7), which connects the tip 5a of each projection 5 and the bottom 4a of the associated recess 4, with respect to the edge line L. In the push cut zone B, the slanting angle θ7 of each distal slanted edge section 7 with respect to the edge line L is larger than the slanting angle θ8 of each basal slanted edge section 8 with respect to the edge line L (θ8<θ7). In the intermediate zone C, the slanting angle θ7 of each distal slanted edge section 7 with respect to the edge line L is equal to the slanting angle θ8 of each basal slanted edge section 8 with respect to the edge line L (θ8=θ7).

Each of the basal slanted edge sections 8 in the pull cut zone A includes an arched edge section 8a having a radius of curvature R8 (not illustrated). Each of the distal slanted edge sections 7 in the push cut zone B includes an arched edge section 7a having a radius of curvature R7 (not illustrated). The center of curvature of each of these arched edge sections 7a, 8a is located outward with respect to the corresponding recess 4 and projection 5. Similarly, each of the distal slanted edge sections 7 in the pull cut zone A includes the arched edge section 7a having the radius of curvature R7. Each of the basal slanted edge sections 8 in the push cut zone B includes the arched edge section 8a having the radius of curvature R8. The center of curvature of each of these arched edge sections 7a, 8a is located inward with respect to the corresponding recess 4 and projection 5. In the pull cut zone A, the radius of curvature R8 of the arched edge section 8a of each basal slanted edge section 8 is smaller than the radius of curvature R7 of the arched edge section 7a of each distal slanted edge section 7. In the push cut zone B, the radius of curvature R7 of the arched edge section 7a of each distal slanted edge section 7 is smaller than the radius of curvature R8 of the arched edge section 8a of each basal slanted edge section 8. In addition, in each of the projecting edge sections 6 of the pull cut zone A and the push cut zone B, the distal slanted edge section 7 and the basal slanted edge section 8 are connected to each other at an edge point 11, or at the tip 5a of the corresponding projection 5.

In the pull cut zone A and the push cut zone B, each of the recessed edge section 9 includes an arched edge section 12, which is formed at the bottom 4a of the corresponding recess 4. Each of the arched edge sections 12 has a radius of curvature R12 (not illustrated). The center of curvature of each arched edge section 12 is located outward with respect to the corresponding recess 4 and projection 5. At each of the arched edge sections 12, the corresponding distal-slanted edge section 7 is connected to the adjacent basal slanted edge section 8. In the intermediate zone C, the projecting edge section 6 includes an arched edge section 13, which is formed at the tip 5a of the projection 5. The arched edge section 13 has a radius of curvature R13 (not illustrated). The center of curvature of the arched edge section 13 is located inward with respect to the corresponding recess 4 and projection 5. At the arched edge section 13, the distal slanted edge section 7 is connected to the basal slanted edge section 8. The recessed edge section 9 located at the boundary between the intermediate zone C and the pull cut zone A and the recessed edge section 9 located at the boundary between the intermediate zone C and the push cut zone B each include an arched edge section 14, which is formed at the bottom 4a of the corresponding recess 4. Each of the arched edge sections 14 has a radius of curvature R14 (not illustrated). The center of curvature of each arched edge section 14 is located outward with respect to the corresponding recess 4 and projection 5. At each of the arched edge sections 14, the corresponding distal slanted edge section 7 is connected to the adjacent basal slanted edge section 8.

When cutting an object P, the illustrated bread cutter is operated in accordance with a push cut mode and a pull cut mode. In the push cut mode, the edge 3 of the body 2 is pushed away from the operator. In the pull cut mode, the edge 3 of the body 2 is pulled toward the operator. Although the cutting modes are applied independently in some cases, the modes may be combined or repeated alternately. Further, in each of the cutting modes, the pull cut zone A and the push cut zone B may be employed independently or in combination. In other words, the cutting modes or the zones A, B may be applied selectively as needed, depending on the conditions for cutting the object P.

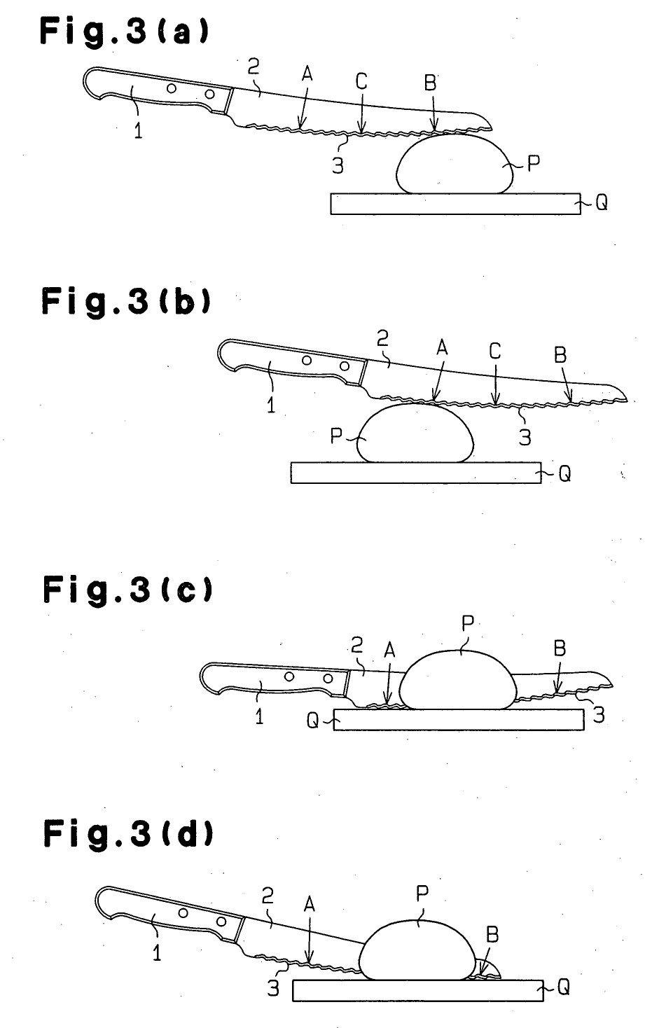

If a baguette is cut as the object P, it is preferred that the push cut zone B of the edge 3 of the body 2 is applied to the surface layer of the object P, with reference to FIG. 3(a). Alternatively, it is preferred that the pull cut zone A of the edge 3 of the body 2 is applied to the surface layer of the object P, with reference to FIG. 3(b). When push cutting is performed from the state of FIG. 3(a), the surface layer of the object P is first cut by the distal slanted edge sections 7 of the push cut zone B, the slanting angles θ7 of which are relatively large. In contrast, when pull cutting is performed from the state of FIG. 3(b), the surface layer of the object P is first cut by the basal slanted edge sections 8 of the pull cut zone A, the slanting angles θ8 of which are relatively large.

However, depending on the type of the object P, it may be preferred that the push cutting is performed by means of the distal slanted edge sections 7 of the pull cut zone A, the slanting angles 97 of which are relatively small. Further, it may be preferred that the pull cutting is performed by means of the basal slanted edge sections 8 of the push cut zone B, the slanting angles θ8 of which are relatively small. In these cases, cutting of the object P may be continued by any one or combination of the cutting modes or the zones A, B, as selected. When finishing the cutting of the object P by the push cutting, it is preferred that the distal slanted edge sections 7 of the pull cut zone A, the slanting angles θ7 of which are relatively small, are moved toward a cutting board Q, with reference to FIG. 3(c). In contrast, when finishing the cutting of the object P by the pull cutting, it is preferred that the basal slanted edge sections 8 of the push cut zone B, the slanting angles θ8 of which are relatively small, are moved toward the cutting board Q, with reference to FIG. 3(d).

FIG. 2(b) shows a modification of the first embodiment. More specifically, in the distal and basal slanted edge sections 7, 8 of the pull cut zone A and the push cut zone B, the center of curvature of each of the arched edge sections 7a, 8a, which have the radiuses of curvature R7, R8, is located outward with respect to the corresponding recess 4 and projection 5.

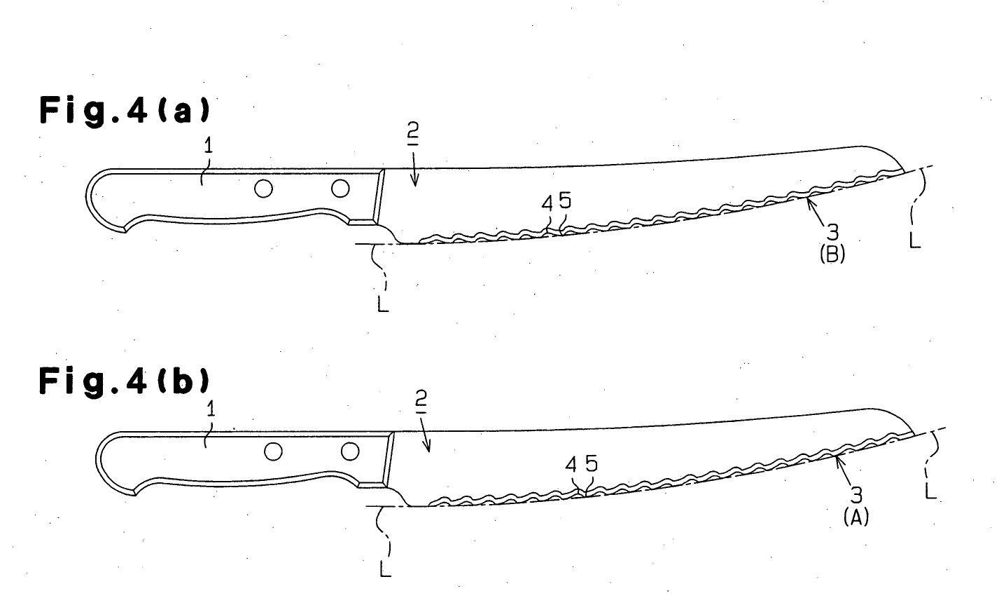

In a second embodiment of the present invention, as shown in FIG. 4(a), the entire portion of the edge 3 of the body 2 is formed uniformly by the distal edge sections 7 and the basal edge sections 8 of the push cut zone B.

In a third embodiment of the present invention, as shown in FIG. 4(b), the entire portion of the edge 3 of the body 2 is formed uniformly by the distal edge sections 7 and the basal edge sections 8 of the pull cut zone B.

Further, the present invention may be applied to different food cutters other than the bread cutter, and even to cutters for different purposes other than food.

1. A cutter comprising an edge extending from a body, the edge including a plurality of recesses and a plurality of projections alternately formed in a continuous manner, the edge also including a plurality of projecting edge sections, each of the projecting edge sections extending at distal and basal sides with respect to a tip of a corresponding one of the projections, each projecting edge section having a distal slanted edge section and a basal slanted edge section connected to each other at the tip of the corresponding projection, with
the shape of each distal slanted edge section being different from the shape of each basal slanted edge section.

2. A cutter comprising an edge extending from a body, the edge including a plurality of recesses and a plurality of projections alternately formed in a continuous manner, the edge also including a plurality of projecting edge sections, each of the projecting edge sections extending at distal and basal sides with respect to a tip of a corresponding one of the projections, each projecting edge section having a distal slanted edge section and a basal slanted edge section connected to each other at the tip of the corresponding projection, wherein
a plurality of zones having the projecting edge sections of different shapes are aligned along a line connecting the tips of the projections.

3. The cutter according to claim 2, wherein each of the distal and basal, slanted edge sections has a curved shape including an arched shape.

4. The cutter according to claim 2, wherein, in terms of the slanting angle of each distal slanted edge section and the slanting angle of each basal slanted edge section with respect to the line connecting the tips of the projections, one of the slanting angles is larger than the other.

5. The cutter according to claim 2, wherein:
in terms of the slanting angle of each distal slanted edge section and the slanting angle of each basal slanted edge section with respect to the line connecting the tips of the projections, one of the slanting angles is larger than the other;
the slanted edge section with the larger slanting angle includes an arched edge section having a center of radius located outward with respect to the corresponding recess and projection; and
the slanted edge section with the smaller slanting angle includes an arched edge section having a center of radius located inward with respect to the corresponding recess and projection.

6. The cutter according to claim 5, wherein the arched edge section of one of the distal and basal slanted edge sections has a radius of curvature smaller than that of the other.

7. A cutter comprising an edge extending from a body, the edge including a plurality of recesses and a plurality of projections alternately formed in a continuous manner, the edge also including a plurality of projecting edge sections, each of the projecting edge sections extending at distal and basal sides with respect to a tip of a corresponding one of the projections, each projecting edge section having a distal slanted edge section and a basal slanted edge section connected to each other at the tip of the corresponding projection, wherein:
the edge includes a first zone and a second zone aligned along a line connecting the tips of the projections;
in the first zone, the slanting angle of each basal slanted edge section with respect to the line is larger than the slanting angle of each distal slanted edge section with respect to the line; and
in the second zone, the slanting angle of each distal slanted edge section with respect to the line is larger than the slanting angle of each basal slanted edge section with respect to the line.

8. The cutter according to claim 7, wherein:
the basal slanted edge sections of the first zone and the distal slanted edge sections of the second zone each include an arched edge section having a center of curvature located outward with respect to the corresponding recess and projection;
the distal slanted edge sections of the first zone and the basal slanted edge sections of the second zone each include an arched edge section having a center of curvature located inward with respect to the corresponding recess and projection; and
the radius of curvature of each arched edge section of the basal slanted edge sections of the first zone and the distal slanted edge sections of the second zone is smaller than the radius of curvature of each arched edge section of the distal slanted edge sections of the first zone and the basal slanted edge sections of the second zone.

9. The cutter according to claim 8, wherein a third zone is defined in the edge and between the first zone and the second zone, and the third zone includes a slanted edge section connected to the corresponding slanted edge section of the first zone and the corresponding slanted edge section of the second zone.

10. The cutter according claim 9, wherein the cutter is a bread cutter.

11. The cutter according to claim 1, wherein each of the distal and basal, slanted edge sections has a curved shape including an arched shape.

12. The cutter according to claim 1, wherein, in terms of the slanting angle of each distal slanted edge section and the slanting angle of each basal slanted edge section with respect to the line connecting the tips of the projections, one of the slanting angles is larger than the other.

13. The cutter according to claim 1, wherein:
in terms of the slanting angle of each distal slanted edge section and the slanting angle of each basal slanted edge section with respect to the line connecting the tips of the projections, one of the slanting angles is larger than the other;
the slanted edge section with the larger slanting angle includes an arched edge section having a center of radius located outward with respect to the corresponding recess and projection; and
the slanted edge section with the smaller slanting angle includes an arched edge section having a center of radius located inward with respect to the corresponding recess and projection.

14. The cutter according to claim 13, wherein the arched edge section of one of the distal and basal slanted edge sections has a radius of curvature smaller than that of the other.

15. The cutter according claim 1, wherein the cutter is a bread cutter.

16. The cutter according to claim 7, wherein a third zone is defined in the edge and between the first zone and the second zone, and the third zone includes a slanted edge section connected to the corresponding slanted edge section of the first zone and the corresponding slanted edge section of the second zone.

17. The cutter according claim 16, wherein the cutter is a bread cutter.
